(19) United States
(12) Patent Application Publication
(10) Pub. No.: US 2026/0245303 A1
(43) Pub. Date: Aug. 20, 2026

(54) SYSTEMS AND METHODS FOR ELEVATION ANALYSIS

(71) Applicant: Washington Surveying & Rating Bureau, Renton, WA (US)

(72) Inventors: Scott Robert Elliott, Spokane, WA (US); Christopher P. Barclay, Spokane, WA (US); Carrie Marie Napier, Seattle, WA (US); Bryan Keith Stanwood, Warrenton, OR (US); Frederick Leonard Spataro, Missoula, MT (US); Rachel Anna Bryant, Missoula, MT (US); Seth Christian Bettwieser, Missoula, MT (US)

(21) Appl. No.: 19/056,535

(22) Filed: Feb. 18, 2025

(51) Int. Cl. G06T 17/05; G01C 21/00; G06F 16/29

(52) U.S. Cl. CPC G06T 17/05; G01C 21/3867; G06F 16/29

(57) ABSTRACT

Systems and methods for building elevation analysis and elevation model generation are described herein. A elevation analysis system receives input indicating a geographic area and a line segment within the geographic area for which elevation analysis is to be performed. The elevation analysis system identifies a structure within the geographic area and generates a geo-database representing the geographic area and the line segment. The elevation analysis system receives an indication of elevation data based on the geographic area and the identified structure. The elevation analysis system receives elevation data and adjusts the geo-database based on the elevation data, including by converting the line segment to a series of two or more points. The elevation analysis system determines a total slope of a portion of the geographic area based on the elevation data and generates a data record based on the total slope.

### BACKGROUND

### Technical Field

The present application is directed to elevation analysis used to determine the slope of the ground in geographic areas. Those that perform elevation analysis (“operators”) typically analyze the elevation by inspecting the highest and lowest points of the geographic area.

### Description of the Related Art

Generally, operators who perform elevation analysis obtain the highest and lowest points of a geographic area. The highest and lowest points are used to determine a slope for the geographic area. The elevation analysis may also be in relation to a building that is included within the geographic area. The slope may be used to detect or otherwise determine the building's propensity of shifting, risk of wildfire damage, risk of earthquake damage, risk of landslide damage, risk of flood damage, and other risks or traits of the building that are affected by the slope of the geographic area within which the building occupies.

### BRIEF SUMMARY

The embodiments described herein address the issues above and thus help solve the technical problems and improve the technology for building elevation analysis via a system that is able to determine a slope for the geographic area. Additionally, the embodiments disclosed herein are able to generate models of the building and geographic area based on the building elevation analysis and determined slope.

According to at least one embodiment of an elevation analysis system, the elevation analysis system receives input indicating a geographic area that may include a structure and a line segment within the geographic area, the line segment representing a first portion of the geographic area. The elevation analysis system may identify whether a structure is located within the geographic area. The elevation analysis system generates a geodatabase that represents the identified structure and the line segment, which represent the geographic area. The elevation analysis system receives an indication of elevation data based on at least the geographic area. The elevation analysis system adjusts the geo-database based on the elevation data, including by converting the line segment to a series of two or more points. The elevation analysis system, for each respective point of two or more points: identifies a point adjacent to the respective point on the line segment and determines a slope of the geographic area between the point and the respective point based on the elevation data. The elevation analysis system determines a total slope of the first portion of the geographic area represented by the line segment based on at least the slope determined for each point of the two or more points. In some embodiments, when a structure is present in the geographic area, the elevation analysis system generates a data record that indicates the total slope of the first portion of the geographic area relative to the structure. In some embodiments, the total slope is indicated as a percent slope relative to the structure.

In some embodiments, the elevation analysis system identifies a second portion of the geographic area based on the geographic data and the identified structure. In some embodiments, the second portion of the geographic area represents a section of the geographic area on which the structure is located. In some embodiments, the elevation analysis system generates a shape based on the input indicating the geographic area.

In some embodiments, the elevation analysis system renders a representation of the structure, geographic area, line segments, the total slope determined by the elevation analysis system, or some combination thereof, based on the geo-database. In some embodiments, the rendered representation includes an indication of the calculated slope of one or more portions of the geographic area. In some embodiments, the elevation analysis system generates a calculated slope for a portion of a geographic area by determining a slope for each pixel in a raster image representing the portion of the geographic area. In some embodiments, the slope for a pixel in the raster image may be calculated based on the elevation of the pixel and its neighboring pixels. In some embodiments, the slope for a pixel may be determined by determining the steepest downward slope with respect to the pixel and at least one neighboring pixel.

In some embodiments, generating the data record includes generating one or more graphs that indicate the elevation of the first or second portion of the geographic area represented by the line segment relative to the structure.

In some embodiments, the elevation analysis system receives the elevation data by transmitting an indication of the geographic area to an elevation data repository and receiving, from the elevation data repository, elevation data representing the geographic area. In some embodiments the elevation analysis system identifies a portion of the elevation data based on the geographic area and the identified structure. In some embodiments the portion of the elevation data represents elevation data for a section of the geographic area on which the structure is located.

In some embodiments, to adjust the geo-database, the elevation analysis system receives geographic data associated with the geographic area based on a raster image. In some embodiments, the elevation analysis system detects whether the portion of the geographic area represented by the line segment intersects with the location of a structure within the geographic area. In some embodiments, the elevation analysis system selects two or more points on the line segment for determining the total slope based on the intersection of the geographic area represented by the line segment with the location of the structure within the geographic area.

In some embodiments, to receive input indicating the geographic area, the elevation analysis system causes a user interface to be presented to a user. In some embodiments, the user interface comprises one or more of: a map, a shape that indicates a geographic area, an indication of one or more structures, or an indication of one or more line segments within the shape. In some embodiments, the elevation analysis system receives input indicating that the shape should be changed or that one or more line segments should be moved. In some embodiments, the elevation analysis system identifies the geographic area and the line segment based on the shape and the indication of the one or more line segments.

In some embodiments, the elevation analysis system includes an elevation data structure that is used to perform one or more functions of the elevation analysis system. In some embodiments, the elevation data structure includes one or more of: information specifying a geographic area including a structure; information specifying a line segment within the geographic area, the line segment representing a first portion of the geographic area; information specifying elevation data; information specifying two or more points on the line segment; or information specifying a total slope of a first portion of the geographic area.

In some embodiments, the elevation data structure includes information specifying a data record indicating the total slope of the first portion of the geographic area relative to the structure. In some embodiments, the information specifying the data record is used to render a representation of the structure, geographic area, line segment, and total slope. In some embodiments, the rendered representation includes an indication of the calculated slope of one or more portions of the geographic area.

In some embodiments, the elevation data structure includes information specifying a data record that indicates the total slope of the first portion of the geographic area relative to the structure. In some embodiments, the information specifying the data record is usable to generate one or more graphs that indicate the elevation of the first or second portion of the geographic area represented by the line segment relative to the structure.

In some embodiments, the elevation data structure includes information specifying a portion of the elevation data that represents elevation data for a section of the geographic area on which the structure is located. In some embodiments, the information specifying the portion of the elevation data is obtained by identifying a portion of the elevation data based on the geographic area and the identified structure. In some embodiments, the information specifying the portion of the elevation data that is not within the selected geographic area is discarded.

In some embodiments, the elevation data structure includes information indicating a geodatabase. In some embodiments, the geodatabase includes one or more of: information specifying a second portion of the geographic area representing a section of the geographic area on which the structure is located, or information specifying the geographic area, or some combination thereof.

In some embodiments, two or more points on the line segment are selected based on the intersection of the geographic area represented by the line segment with the location of the structure within the geographic area.

### BRIEF DESCRIPTION OF THE SEVERAL VIEWS OF THE DRAWINGS

FIG. 1 is a block diagram of an elevation analysis system, according to various embodiments described herein.

FIG. 2 is a flow diagram of a process to perform a building elevation analysis, according to various embodiments described herein.

FIG. 3 is a user interface for receiving a selection of a building, according to various embodiments described herein.

FIG. 4 is a user interface for specifying a geographic area, according to various embodiments described herein.

FIG. 5 is a user interface for specifying a geographic area and displaying a total slope for one or more portions of a geographic area within which a building is located, according to various embodiments described herein.

FIG. 6 is a flow diagram of a process for creating a geodatabase representing a geographic area, according to various embodiments described herein.

FIG. 7 is a flow diagram of a process for calculating a slope for a portion of a geographic area according to various embodiments described herein.

FIG. 8 is a diagram of a first graph and second graph generated by the elevation analysis system based on a geo-database that represent the elevation of the building along one or more portions of a geographic area according to various embodiments described herein.

FIG. 9 is a diagram of an elevation model generated by the elevation analysis system based on the geo-database according to various embodiments described herein.

FIG. 10 is a diagram of a report generated by an elevation analysis system, according to various embodiments described herein.

FIG. 11 is a diagram of an environment within which an elevation analysis system may operate, according to various embodiments described herein.

### DETAILED DESCRIPTION

The present disclosure is directed to an elevation analysis system for determining a slope for a geographic area. The elevation analysis system is able to generate models of the building and geographic area based on the building elevation analysis and determined slope.

Unless the context requires otherwise, throughout the specification and claims which follow, the word “comprise” and variations thereof, such as, “comprises” and “comprising” are to be construed in an open, inclusive sense, for example “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. The term “or” is generally employed in its sense including “and/or” unless the content clearly dictates otherwise.

The headings and Abstract of the Disclosure provided herein are for convenience only and do not interpret the scope or meaning of the embodiments.

Conventional methods of elevation analysis include calculating a total slope of a geographic area based on only a high point of the geographic area and a low point of the geographic area. The total slope is used to detect or otherwise determine the building's propensity of shifting, risk of wildfire damage, risk of earthquake damage, risk of landslide damage, risk of flood damage, and other risks or traits of the building or geographic area. However, such methods are unable to accurately assess the slope from one end of the geographic area to another end of the geographic area, unable to be used to create an accurate representation of the property, and do not consider features of the rest of the terrain. Thus, the total slope determined with conventional methods is unable to be used to accurately detect or determine risks or traits of the building or geographic area.

Implementations of the present disclosure are directed to computer-implemented systems and methods for building elevation analysis within a geographic area. The elevation analysis system may be used to determine a total slope for the geographic area with fewer resources than normally necessary to determine the total slope for the geographic area. The elevation analysis system is additionally able to determine the total slope with equal or greater accuracy than other conventional methods while using fewer resources than would be necessary to be used by such conventional methods to determine the total slope with a comparable level of accuracy. Furthermore, the elevation analysis system may be used to generate a model of the geographic area including the building.

Such implementations are thus able to improve the functioning of computer or other hardware, such as by reducing the dynamic display area, processing, storage, and/or data transmission resources needed to perform a certain task, thereby enabling the task to be performed by less capable, and/or less expensive, hardware devices, and/or be performed with lesser latency, and/or preserving more valuable resources for use in performing other tasks. For example, removing elevation data for portions of the geographic area that aren't being used to measure the slope, allows the elevation analysis system to calculate the slope by using less memory resources to store data describing the geographic area. In another example, the elevation analysis system uses a reference dataset and the selected geographic area to more quickly locate and access high-resolution elevation data for use by the elevation analysis system, thus reducing the processing and memory resources needed to locate high-resolution elevation data in comparison to conventional methods of elevation analysis that search through high-resolution elevation data directly. In yet another example, the elevation analysis system provides data gathered from multiple sources about the selected geographic area and generates a representation of that data in a single location, thus reducing the effort required by the user to gather that data. Furthermore, such implementations are able to create more accurate representations of the geographic area and building elevation, as well as to better detect and determine risks and traits of the building or geographic area, than conventional methods.

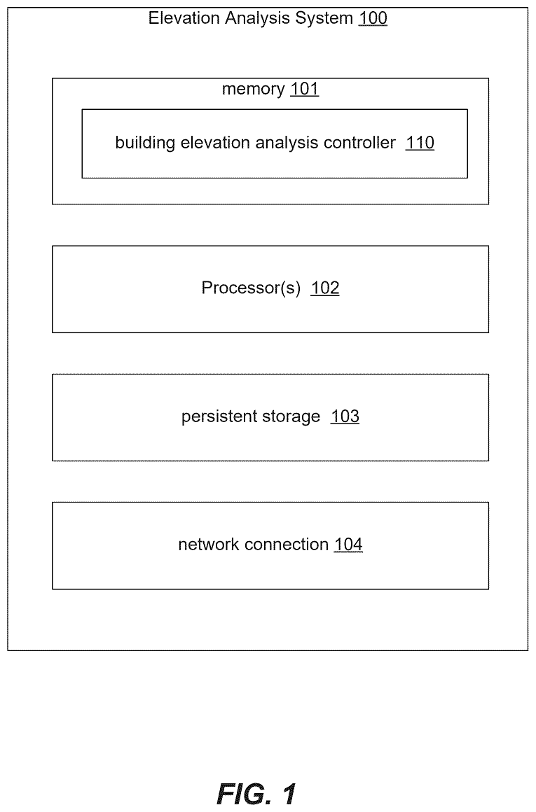

FIG. 1 is a block diagram of an elevation analysis system 100, according to various embodiments described herein. In various embodiments, the elevation analysis system 100 includes one or more of the following: a computer memory 101 for storing programs and data, including data associated with the building elevation analysis, a geo-database for a geographic area, polygon representations of the geographic area, elevation data for the geographic area, a user interface for receiving an indication of a geographic area, an operating system including a kernel, and device drivers; one or more processors 102 for executing computer programs; a persistent storage device 103, such as a hard drive or flash drive for persistently storing programs and data; and a network connection 104 for communicatively connecting to one or more computer devices, computing systems that provide or store elevation data, and/or other computer systems, to send and/or receive data, such as via the Internet or another network and associated networking hardware, such as switches, routers, repeaters, electrical cables and optical fibers, light emitters and receivers, radio transmitters and receivers, and the like. In various embodiments, the elevation analysis system 100 additionally includes user input and output devices, such as a keyboard, a mouse, display devices, etc.

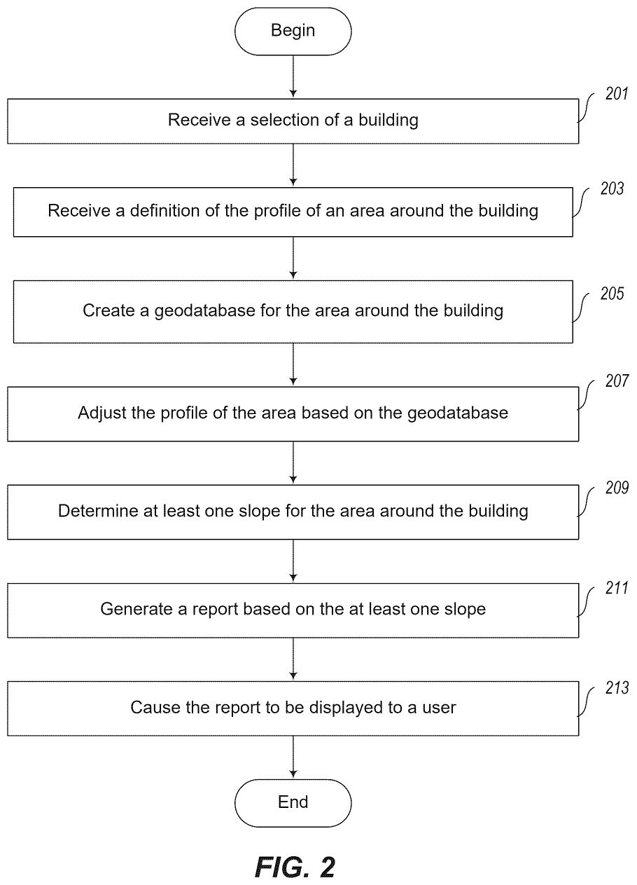

The memory 101 may include a building elevation analysis controller 110. The building elevation analysis controller 110 performs the core functions of the elevation analysis system 100, such as the aspects described below with respect to FIGS. 2-11. In particular, the building elevation analysis controller 110 may be used to generate a total slope for a geographic area within which a building is located, and generate a model based on the slope.

In particular, the building elevation analysis controller 110 may receive an indication of a geographic area and a building and determine a slope for a portion of the geographic area around the building. The determined slope may indicate one or more features of the terrain within the portion of the geographic area. In some embodiments, the building elevation analysis controller 110 may generate a data record that includes a model of the geographic area.

In an example embodiment, the building elevation analysis controller 110 and/or computer-executable instructions stored on memory 101 of the elevation analysis system 100 are implemented using standard programming techniques. For example, the building elevation analysis controller 110 and/or computer-executable instructions stored on memory 101 of the elevation analysis system 100 may be implemented as a “native” executable running on 102, along with one or more static or dynamic libraries. In other embodiments, the building elevation analysis controller 110 and/or computer-executable instructions stored on memory 101 of the elevation analysis system 100 may be implemented as instructions processed by a virtual machine that executes as some other program.

The embodiments described above may also use synchronous or asynchronous client-server computing techniques. However, the various components may be implemented using more monolithic programming techniques as well, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously, and communicate using message passing techniques. Equivalent synchronous embodiments are also supported. Also, other functions could be implemented and/or performed by each component/module, and in different orders, and by different components/modules, yet still achieve the functions of the elevation analysis system 100.

In addition, programming interfaces to the data stored as part of the building elevation analysis controller 110 can be available by standard mechanisms such as through C, C++, C#, Java, and Web APIs; libraries for accessing files, databases, or other data repositories; through scripting languages such as JavaScript and VBScript; or through Web servers, FTP servers, or other types of servers providing access to stored data. The building elevation analysis controller 110 may be implemented by using one or more database systems, file systems, or any other technique for storing such information, or any combination of the above, including implementations using distributed computing techniques.

Different configurations and locations of programs and data are contemplated for use with techniques described herein. A variety of distributed computing techniques are appropriate for implementing the components of the embodiments in a distributed manner including but not limited to TCP/IP sockets, RPC, RMI, HTTP, Web Services (XML-RPC, JAX-RPC, SOAP, and the like). Other variations are possible. Also, other functionality could be provided by each component/module, or existing functionality could be distributed amongst the components/modules in different ways, yet still achieve the functions of the elevation analysis system 100.

Furthermore, in some embodiments, some or all of the components or portions of the building elevation analysis controller 110, and/or functionality provided by the computer-executable instructions stored on memory 101 of the elevation analysis system 100 may be implemented or provided in other manners, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., as a hard disk; a memory; a computer network or cellular wireless network; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques. Such computer program products may also take other forms in other embodiments. Accordingly, embodiments of this disclosure may be practiced with other computer system configurations.

In general, a range of programming languages may be employed for implementing any of the functionality of the servers, functions, electrical power grid, electrical power grid components, etc., present in the example embodiments, including representative implementations of various programming language paradigms and platforms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, PHP, Python, JavaScript, VBScript, and the like) and declarative (e.g., SQL, Prolog, and the like).

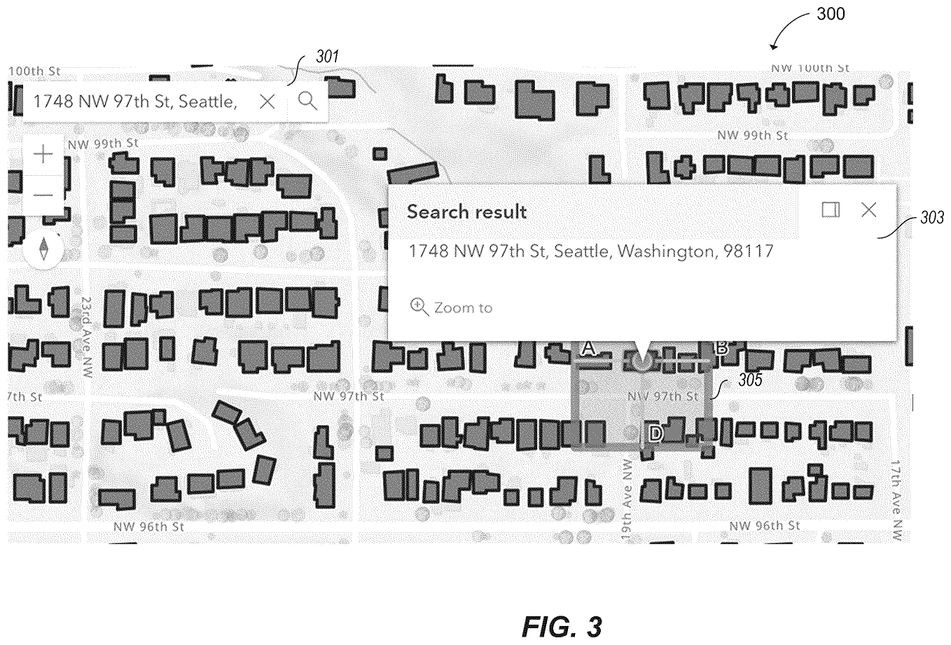

The network connection 104 is a wired connection, wireless connection, or some combination thereof used by the elevation analysis system 100 in some embodiments. The elevation analysis system 100 may use the network connection 104 to transmit a data record generated by the building elevation analysis controller 110 to a user computing device. For example, the elevation analysis system 100 may transmit an instruction to display a webpage that includes information included in the data record to a user computing device via the network connection 104. Furthermore, in some embodiments, the elevation analysis system 100 causes one or more user interfaces, such as the user interfaces 300, 400, and 500 described below in connection with FIGS. 3, 4, and 5, to be displayed by a user computing device by transmitting one or more messages to the user computing device via the network connection 104. The network connection 104 may also be used to receive input from a user that was entered on a user computing device and transmitted from the user computing device to the elevation analysis system 100.

FIG. 2 is a flow diagram of a process 200 to perform a building elevation analysis, according to various embodiments described herein. In some embodiments, the process 200 is performed by an elevation analysis system, such as the elevation analysis system 100 described above with respect to FIG. 1.

The process 200 begins, after a start block, at act 201, where an elevation analysis system receives a selection of a building. In some embodiments, the elevation analysis system receives the selection of the building via one or more user interfaces, such as the user interfaces described below in connection with FIGS. 3, 4, and 5. In some embodiments, at act 201, the elevation analysis system receives a selection of a geographic area via the one or more user interfaces, instead of a selection of a building. In some such embodiments, the elevation analysis system may identify a building included in the geographic area based on geographic data indicating the location of one or more buildings. In some embodiments, the elevation analysis system may perform any of the aspects of the processes 200, 600, and 700 without identifying a building.

After act 201, the process 200 proceeds to act 203, where the elevation analysis system receives a definition of the profile of an area around the building. In some embodiments, the elevation analysis system receives the definition of the profile of the area via one or more user interfaces, such as the user interfaces described below in connection with FIGS. 3, 4, and 5.

After act 203, the process 200 proceeds to act 205 where the elevation analysis system creates a geo-database for the area around the building. In some embodiments, a geo-database includes data types that indicate a polygon that represents the building, coordinates for the polygon in one or more of the x, y, or z planes. The geo-database may include a spatial representation of the building. In embodiments where the area does not include a building, the elevation analysis system geodatabase does not include data that represents the building.

In some embodiments, the geo-database includes a portion of a raster image that represents the geographic area including the building. The portion of the raster image may include additional data for each pixel of the portion of the raster image that indicates an elevation above sea level at a geographic location represented by the pixel. In some embodiments, the elevation analysis system receives the portion of the raster image by identifying one or more pixels of the raster image based on a geographic area, such as a geographic area associated with a building, received via user input, etc.

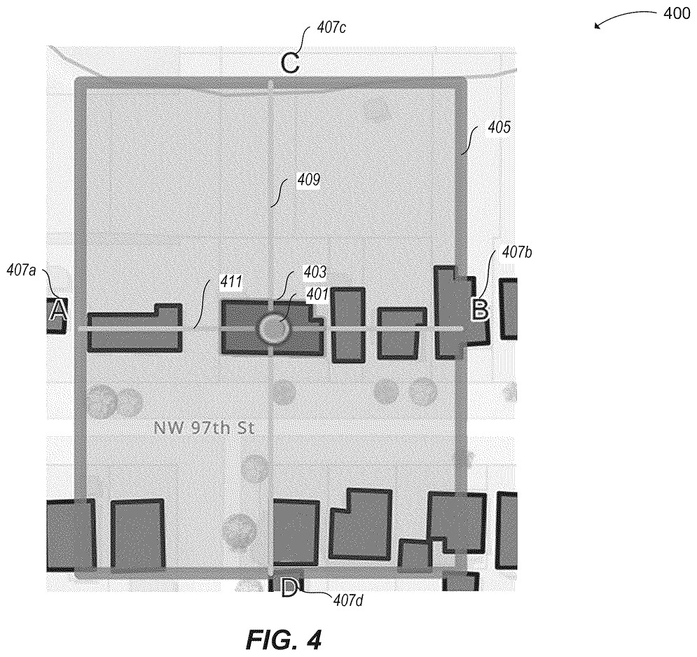

In some embodiments, the geo-database includes an indication of the portions of the geographic area for which the slope is to be calculated. In some embodiments, the portions of the geographic area for which the slope is to be calculated are represented by a plurality of “points”. In an example embodiment, each “point” may correspond to a pixel of the portion of the raster image that represents the geographic area. In some embodiments, the elevation analysis system identifies the points based on a selected portion of the geographic area for which the slope is to be calculated, such as the portions selected as described below in connection with FIG. 4.

In some embodiments, when a building is not located in the geographic area, the elevation analysis system continues to perform the process 200 without taking into account a building in the geographic area. In some embodiments, when a building is not located in the geographic area, the elevation analysis system indicates to a user that a building is not located within the geographic area for which geographic data analysis is requested.

In some embodiments, when the elevation analysis system is not able to access geographic data for a geographic area, the elevation analysis system indicates to a user that the geographic data is unavailable for the geographic area. In such embodiments, the elevation analysis system may receive a raster image, vector data, etc., that includes geographic data for the area at one or more resolutions. In some embodiments, the elevation analysis system may format the raster image, vector data, etc., and automatically update the reference data to include the raster image, vector data, etc., that corresponds to the geographic area. In some embodiments, the elevation analysis system may format the raster image, vector data, etc., and a user is required to update the reference data for the raster image, vector data, etc., that correspond to the geographic area.

After act 205, the process 200 proceeds to act 207, where the elevation analysis system adjusts the profile of the area based on the geo-database. In some embodiments, adjusting the profile of the area based on the geo-database includes: detecting whether the portion of the geographic area represented by a location received via input intersects with the location of a structure within the geographic area, adjusting one or more projections for geographic data (for example, elevation data) associated with the geographic area, selecting two or more points on the line segment based on the intersection of the geographic area represented by the line segment with the location of the structure within the geographic area, or some combination thereof. In some embodiments, the elevation analysis system uses the location received via input to identify one or more latitude, longitude, or other “geo-coded” points within the geographic area. In some embodiments, the elevation analysis system determines whether a geo-coded point intersects with the location of a structure within the geographic area. In some such embodiments, the elevation analysis system determines that there is no structure in the geographic area based on a determination that one or more geo-coded points do not intersect with the location of a structure within the geographic area. In some embodiments, elevation data associated with the geographic area is obtained from an elevation database that includes geological survey data, such as data provided by the US Geological Survey or other geological surveys. The elevation data may have different resolutions, such as elevation data for a ninety square meter geological area, sixty square meter area, thirty square meter area, ten square meter area, one square meter area, and so on.

In some embodiments, the elevation analysis system receives elevation data for the selected geographic area that is used to analyze the slope for a portion of the geographic area and precalculated reference slope data for the selected geographic area. In some embodiments, the elevation analysis system generates precalculated reference slope data for a portion of a geographic area by determining a slope for each pixel in a raster image representing the portion of the geographic area. The raster image may include elevation data representing an elevation at each pixel of the raster image. In some embodiments, the slope for a pixel in the raster image may be calculated based on the elevation of the pixel and its neighboring pixels. In some embodiments, the slope for a pixel may be determined by determining the steepest downward slope with respect to the pixel and at least one neighboring pixel.

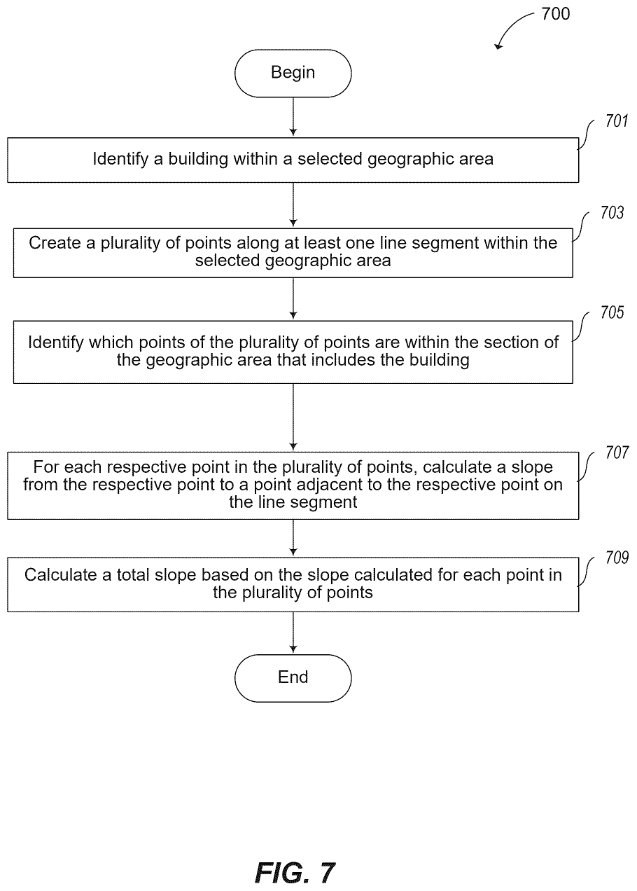

After act 207, the process 200 proceeds to act 209, where the elevation analysis system determines at least one slope for the area around the building. In some embodiments, the elevation analysis system determines at least one slope for the area around the building based on the geo-database and a points layer included in the geo-database. For example, the elevation analysis system may use the process described below with respect to FIG. 7 to determine at least one slope.

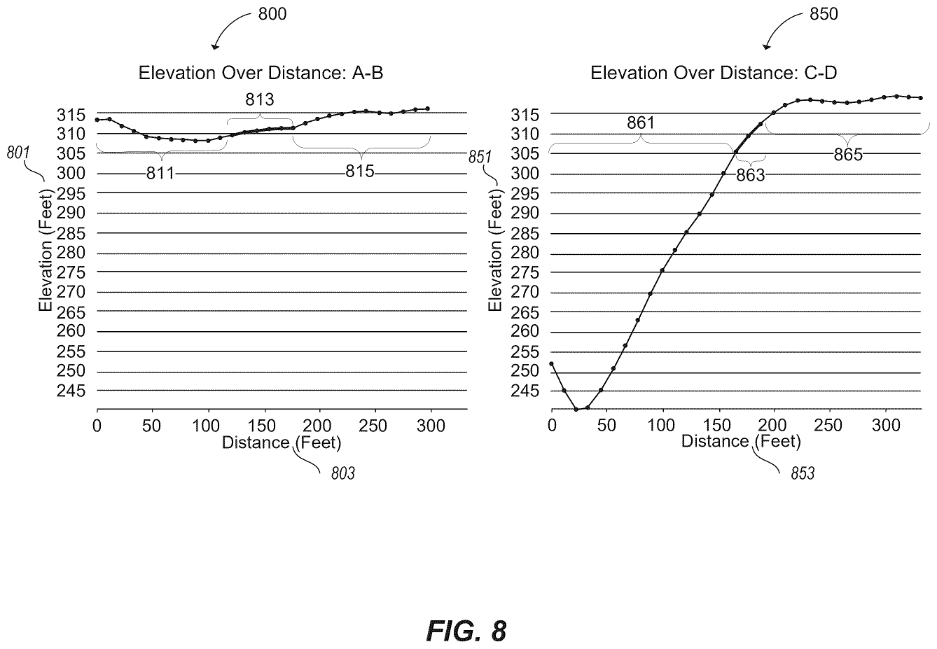

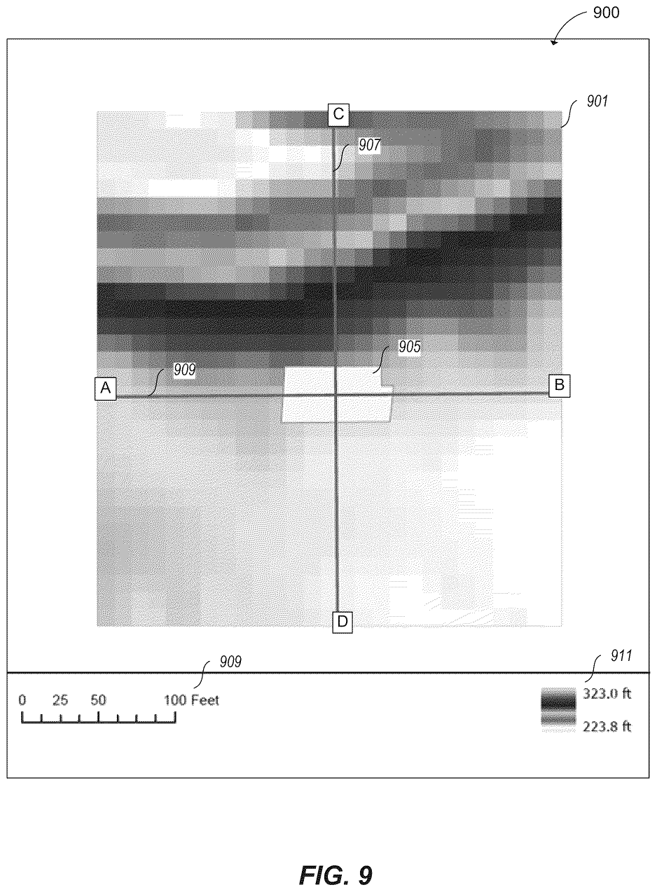

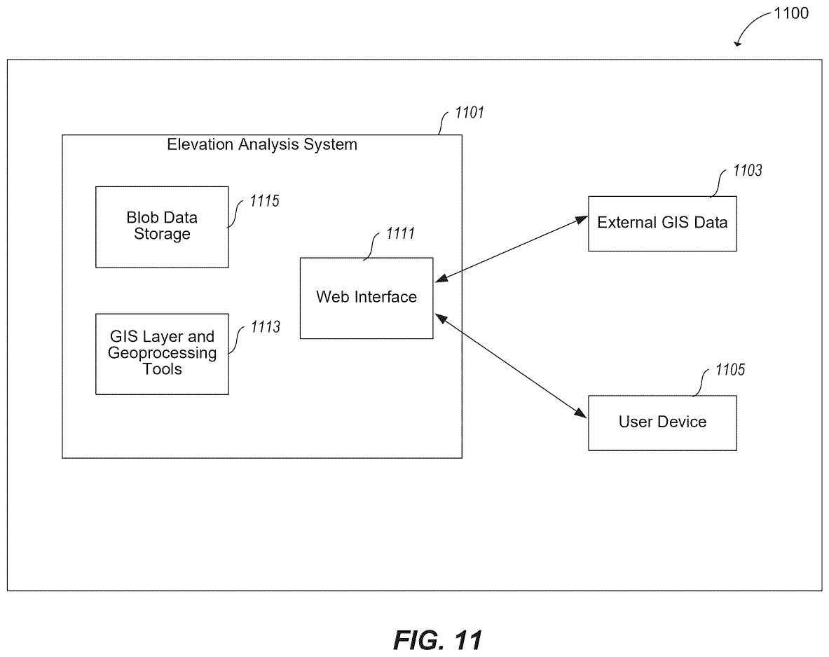

After act 209, the process 200 proceeds to act 211, where the elevation analysis system generates a report, or “data record,” based on the at least one slope. The report may include one or more graphs that indicate the change in the elevation along a portion of the geographic area, such as the graphs 800 and 850 described below in connection with FIG. 8. In some embodiments, the report includes a model of the building and geographic area, such as the model 900 described below with respect to FIG. 9. In some embodiments, as part of performing act 209, the geographic elevation analysis system receives additional geographic data for the geographic area from one or more additional raster images, vector data, etc., stored by the elevation analysis system, such as in the blob data storage 1115 described below in connection with FIG. 11, GIS Layer and Geoprocessing Tools 1113 described below in connection with FIG. 11, or some combination thereof. In such embodiments, the elevation analysis system may receive the additional geographic data in a similar manner to obtaining the portion of the raster image that represents the geographic area including the building.

After act 211, the process 200 proceeds to act 213, where the elevation analysis system causes the report to be displayed to a user. In some embodiments, causing the report to be displayed to the user includes generating representation of the model and transmitting the representation of the model to a computing device associated with the user.

After act 213, the process 200 ends.

In some embodiments, the elevation analysis system receives an indication of multiple geographic areas via user input. In such embodiments, the elevation analysis system may perform the process 200 for each of the geographic areas received. In some such embodiments, if the process 200 is not able to be performed for one or more of the geographic areas, such as if elevation data cannot be found for the geographic areas, the elevation analysis system may indicate to a user that the process 200 is unable to be performed for the one or more geographic areas. elevation analysis system

FIG. 3 is a user interface 300 for receiving a selection of a geographic area that may include a building, property lot, etc., according to various embodiments described herein. The user interface 300 includes an address text box 301, a search result text box 303, and a geographic area box 305. The address text box 301 receives input indicating an address. In some embodiments, the input indicating the address is one or more of: a postal address; geographic coordinates, such as latitude and longitude coordinates; or another indication of a building. The search result text box 303 indicates the postal address of a geographic area that is indicated by the input in the address text box 301. The geographic area box 305 indicates a geographic area that includes a building, property lot, etc., indicated in the address text box 301. In some embodiments, the geographic area box 305 is a shape other than a rectangle.

FIG. 4 is a user interface 400 for specifying a geographic area, according to various embodiments described herein. The user interface 400 includes a geographic area box 405, sides 407a, 407b, 407c, and 407d, a center point 401, a building representation 403, a first portion of the geographic area 409, and a second portion of the geographic area 411.

The center point 401 indicates a center point of a building indicated by a user, such as a building selected via the user interface 300 described above in connection with FIG. 3. The building representation 403 is a representation of the selected building, such as a polygon representation of an outline of the building.

The geographic area box 405 is a representation of the bounds of the geographic area within which the building is located. In some embodiments, the geographic area box 405 is a shape other than a rectangle. The sides 407a, 407b, 407c, and 407d are each sides of the geographic area box 405. In embodiments where the geographic area box 405 is not a rectangle, additional or fewer sides may be included in the user interface 400. In some embodiments, a user is able to alter the dimensions of the geographic area box 405 by manipulating one or more of the sides 407a, 407b, 407c, and 407d. In some embodiments, the geographic area box 405 is able to be moved such that the center point 401 of the building is not located in the center of the geographic area box 405.

The first portion of the geographic area 409 represents a first portion of the geographic area represented by the geographic area box 405 for which at least one slope is calculated. The second portion of the geographic area 411 represents a second portion of the geographic area represented by the geographic area box 405 for which at least one slope is calculated. Although two portions of the geographic area are depicted in the user interface 400, embodiments are not so limited, and additional or fewer portions of the geographic area may be depicted. In some embodiments, the user interface 400 is able to receive user input indicating that the first or second portion of the geographic area is to be changed. In some embodiments, at least one of the portions of the geographic area for which at least one slope is calculated represents a portion of the geographic area within which a building is not included.

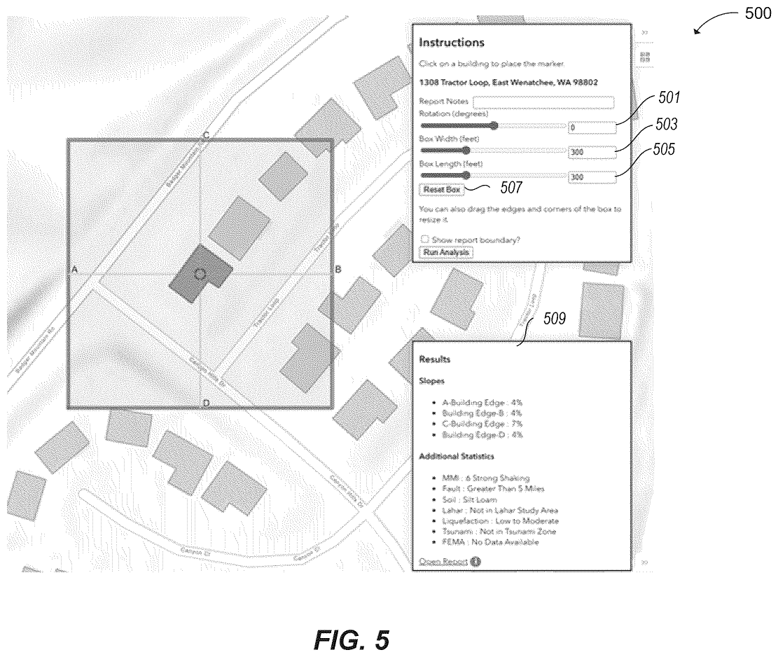

FIG. 5 is a user interface 500 for specifying a geographic area and displaying a total slope for one or more portions of a geographic area within which a building is located, according to various embodiments described herein. The user interface 500 includes a rotation slider 501, a box width slider 503, a box length slider 505, a reset button 507, and a results box 509.

Manipulation of the rotation slider 501 rotates the geographic area. For example, manipulating the rotation slider 501 to indicate thirty degrees causes the geographic area to be adjusted such that it is rotated by thirty degrees. Manipulation of the box width slider 503 changes a width of the geographic area. For example, manipulating the box width slider 503 to indicate a width of one-hundred feet causes the geographic area to be adjusted such that the width of the geographic area is one-hundred feet. Manipulation of the box length slider 505 changes a length of the geographic area. For example, manipulating the box length slider 505 to indicate a length of one-hundred feet causes the geographic area to be adjusted such that the length of the geographic area is one-hundred feet. Activating the reset button 507 resets the bounds and rotation of the geographic area to a default state.

The results box 509 indicates the result of the building elevation analysis performed by the elevation analysis system for the geographic area. The results box 509 indicates that the slope for the portion of the geographic area from point A on the geographic area to the edge of the building is “5.8%”. Likewise, the results box 509 indicates the slope for the portion of the geographic area from point B to the edge of the building, from point C to the edge of the building, and from point D to the edge of the building. The results box 509 additionally includes a button used to cause the report to be downloaded to a user computing device.

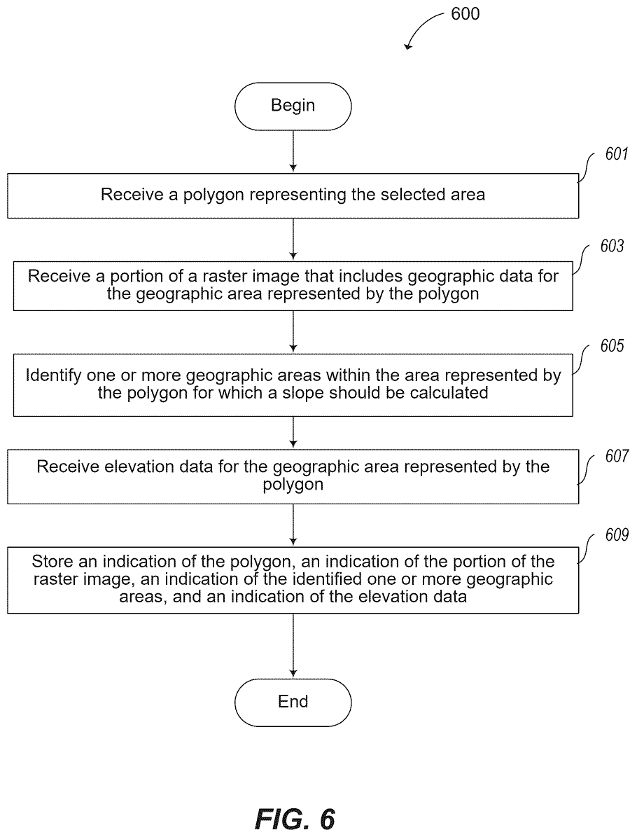

FIG. 6 is a flow diagram of a process 600 for creating and storing a geo-database representing a geographic area, according to various embodiments described herein. In some embodiments, the process 600 is performed by an elevation analysis system, such as the elevation analysis system 100 described above with respect to FIG. 1.

The process 600 begins, after a start block, at act 601 where the elevation analysis system receives a polygon representing a selected geographic area. In some embodiments, an indication of the polygon is received via input from one or more user interfaces, such as the user interfaces 300, 400, and 500 described above with respect to FIGS. 3, 4, and 5.

After act 601, the process 600 proceeds to act 603, where the elevation analysis system receives a portion of a raster image that includes geographic data for the geographic area represented by the polygon. In some embodiments, the geographic data includes: an elevation for one or more points in the geographic area, a slope of one or more points of the geographic area, other geographic data, or some combination thereof. In some embodiments, the elevation analysis system may identify reference pixels of the raster image used to identify a location in memory of one or more additional raster images, such as a slope raster image corresponding to the geographic area, an elevation raster image corresponding to the geographic area, etc.

By using a reference dataset that stores the location in memory of the raster images, the elevation analysis system is able to identify the location in memory of the raster image that would be represented by the selected geographic area more quickly than if the entire set of available raster images were searched. Furthermore, identifying the pixels of the reference dataset that correspond to the geographic area allow the elevation analysis system to store a reference of the raster image that corresponds to the geographic area instead of storing a copy of the raster image. By operating in this manner, embodiments of the elevation analysis system may provide a technical solution to the technical problem of searching large, high-resolution, raster images to obtain data regarding a geographic area.

In some embodiments, the reference dataset includes a plurality of raster images, such as raster images received from an external geographic information system. In some such embodiments, the plurality of raster images may have overlapping data. For example, a raster image for elevation data in a county may have overlapping data with a raster image for elevation data in a town that neighbors the county. In some embodiments, the reference dataset includes a reference that links a plurality of points in a geographic area to one or more raster images. For example, the reference dataset may include raster images that are linked to latitude and longitude coordinates that indicate the area for which the raster image indicates geographic data. In this example, the elevation system may receive a latitude and longitude and use the received latitude and longitude to identify a raster image by using the reference dataset. In some embodiments, where the raster images are stored in blob storage, the elevation system may receive an indication of a memory location of one or more raster images that include geographic data associated with latitude and longitude coordinates from the reference dataset, such as a filename, memory address, other indications of a memory location, or some combination thereof. In some embodiments, the elevation analysis system trims a portion of a raster image based on a geographic area, such as a geographic area within the area represented by the polygon for which a slope should be calculated, described below in connection with act 603.

After act 603, the process 600 proceeds to act 605, where the elevation analysis system identifies one or more geographic areas within the area represented by the polygon for which a slope should be calculated. In some embodiments, the elevation analysis system receives an indication of the portion of the raster image based on the geographic areas for which a slope should be calculated. In some embodiments, the one or more geographic areas are identified via user interfaces, such as the user interfaces 300, 400, and 500 described above in connection with FIGS. 3, 4, and 5.

After act 605, the process 600 proceeds to act 607, where the elevation analysis system receives elevation data for the geographic area represented by the polygon. In some embodiments, the elevation analysis system receives the elevation data from the portion of the raster image received in act 603, such as by accessing data of the raster image. In some embodiments, the elevation analysis system creates a set of one or more points for calculating the slope of the geographic areas identified in act 605 based on the identified geographic areas and the portion of the raster image. In some embodiments, each point may correspond to a pixel of the portion of the raster image that represents a location within the geographic areas for which slope is to be calculated. In some embodiments, the points include data indicating whether the point is within a portion of the geographic area on which a building is located. In some embodiments, the points are stored in a geo-database as a “points layer” during act 609, described below.

After act 607, the process 600 proceeds to act 609, where the elevation analysis system stores an indication of the polygon, an indication of the portion of the raster image, an indication of the identified one or more geographic areas, and an indication of the elevation data in a geo-database.

After act 609, the process 600 ends. In some embodiments, the elevation analysis system receives additional geographic data, such as: a modified Mercalli index, lahar presence, a soil type, the ground's susceptibility to liquification, a tsunami risk, a distance to a fault line, a flood zone designation, other geographic data, or some combination thereof. In such embodiments, the additional geographic data may be stored as raster images, vector features, other types of images or methods of storing and accessing geographic data, or some combination thereof. In some embodiments, the elevation analysis system receives the additional geographic data in a similar manner to act 603, described above.

FIG. 7 is a flow diagram of a process 700 for calculating a slope for a portion of a geographic area according to various embodiments described herein. In some embodiments, the process 700 is performed by an elevation analysis system, such as the elevation analysis system 100 described above with respect to FIG. 1.

The process 700 begins, after a start block, at act 701 where the elevation analysis system identifies a building within a selected geographic area. The elevation analysis system may identify the building based on a representation of the geographic area and an indication of the location of the building.

After act 701, the process 700 proceeds to act 703, where the elevation analysis system creates a plurality of points along at least one line segment within the selected geographic area. The line segment may represent a portion of the geographic area for which a slope is to be calculated. In some embodiments, the plurality of points are identified based on the elevation data of the geographic area, such as the raster image received as part of performing the process 600 described above in connection with FIG. 6.

After act 703, the process 700 proceeds to act 705, where the elevation analysis system identifies which points of the plurality of points are within the section of the geographic area that includes the building. In some embodiments, the elevation analysis system identifies the points that are within the section of the geographic area that includes the building based on data included in the geo-database, such as data identifying the building and the selected geographic area.

After act 705, the process 700 proceeds to act 707, where the elevation analysis system, for each respective point in the plurality of points, calculates a slope from the respective point to a point adjacent to the respective point on the line segment.

After act 707, the process 700 proceeds to act 709, where the elevation analysis system calculates a total slope based on the slope calculated for each point in the plurality of points. In some embodiments, the calculated total slope is expressed as a percentage. In some embodiments, the calculated total slope is determined based on an incremental slope, which is an average of the slopes calculated for each point in the plurality of points. For example, if a line has three points, one at each end and one in the middle, the incremental slope would be determined by averaging the slope between the point at one end and the point in the middle and the slope between the point in the middle and the point at the other end.

After act 709, the process 700 ends.

FIG. 8 is a diagram of a first graph 800 and second graph 850 generated by the elevation analysis system based on a geo-database that represent the elevation of the building along one or more portions of a geographic area according to various embodiments described herein. The first graph 800 is a graph that represents the elevation for points along a portion of the geographic area. In an example embodiment, the first graph 800 represents the elevation for points along the portion of the geographic area denoted by the second portion of the geographic area 411 described above in connection with FIG. 4. The second graph 850 is a graph that represents the elevation for points along the first portion of the geographic area. In an example embodiment, the second graph 850 represents the elevation for points along the portion of the geographic area denoted by the first portion of the geographic area 409 described above in connection with FIG. 4.

The first graph 800 and second graph 850 each have a y-axis (axis 801 and axis 851 respectively) that indicates the elevation of a portion of the geographic area, such as the elevation indicated by a pixel of the raster image of the geographic area. The first graph 800 and second graph 850 each have an x-axis (axis 803 and axis 853 respectively) that indicates the distance of a portion of the geographic area from one edge of the geographic area to another. For example, in the graph 800 the portion of the geographic area that is at edge “A” has a distance of zero and the portion of the geographic area at edge “B” has a distance of 300.

The first graph 800 indicates first points 811, second points 813, and third points 815. The first points 811 indicate the elevation and distance from the edge for a first portion of the pixels of the second portion of the geographic area. The second points 813 indicate the elevation and distance from an edge for a second portion of the pixels of the second portion of the geographic area that are located within the area occupied by the building. The third points 815 indicate the elevation and distance from an edge for a third portion of the pixels of the second portion of the geographic area.

The second graph 850 indicates fourth points 861, fifth points 863, and sixth points 865. The fourth points 861 indicate the elevation and distance from the edge for a first portion of the pixels of the first portion of the geographic area. The fifth points 863 indicate the elevation and distance from an edge for a second portion of the pixels of the first portion of the geographic area that are located within the area occupied by the building. The sixth points 865 indicate the elevation and distance from an edge for a third portion of the pixels of the first portion of the geographic area.

FIG. 9 is a diagram of an elevation model 900 received by the elevation analysis system according to various embodiments described herein. The elevation model 900 includes an elevation image 901, a distance scale 909, and an elevation scale 911. The distance scale 909 is a cartographic scale that indicates the scale of the elevation map 901. The elevation scale 911 is an elevation scale that indicates the elevation values of one or more areas depicted in the elevation map 901. For example, the elevation scale 911 indicates that lighter areas of the elevation map 901 indicate lower elevation and that darker areas of the elevation map 901 indicate higher elevation.

The elevation map 901 indicates a building 905, a first portion of the geographic area 907 and a second portion of the geographic area 909. The building 905 indicates the geographic area within which the building is located. The first portion of the geographic area 907 indicates a portion of the geographic area for which a total slope has been calculated. The second portion of the geographic area 909 indicates a second portion of the geographic area for which a second total slope has been calculated. In some embodiments, the elevation map 901 is a three-dimensional representation of the geographic area and building.

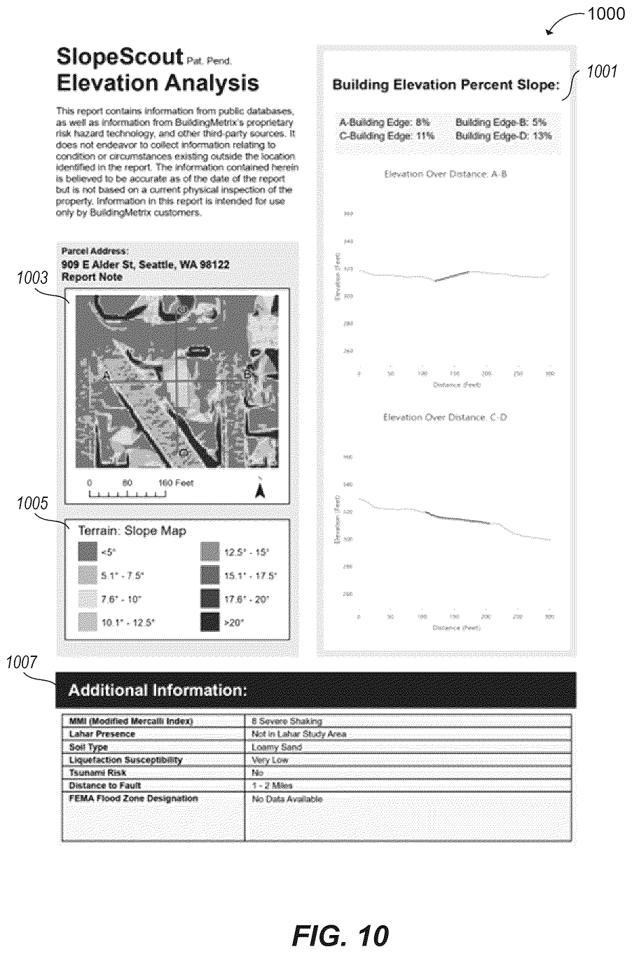

FIG. 10 is a diagram of a report 1000 generated by an elevation analysis system, according to various embodiments described herein. The report 1000 includes a slope chart 1001, a slope map 1003, a map key 1005, and an additional geographic data section 1007. The slope chart 1001 includes measurements of the slope of a geographic area along one or more edges of a building in a geographic area. The slope chart 1001 also includes one or more graphs that indicate the elevation within the geographic area for one or more portions of the geographic area. In some embodiments, the slope chart 1001 includes graphs similar to the graphs 800 and 850, described above in connection with FIG. 8.

The slope map 1003 depicts a geographic area, a building within the geographic area, and one or more portions of the geographic area for which slope is calculated. The slope map 1003 may additionally include a depiction of calculated slope data for the geographic area. The colors of the slope map 1003 that correspond to the degree of the calculated slope data are indicated by the map key 1005. In some embodiments, the slope map 1003 is instead an elevation map that indicates the elevation of one or more portions of the geographic area for which the slope is calculated.

The additional geographic data section 1007 includes additional geographic data describing the geographic area indicated by the slope map 1003. In some embodiments, the additional geographic data is received by the elevation analysis system based on one or more raster images, one or more vector features, one or more other sources of geographic data, or some combination thereof.

FIG. 11 is a diagram of an environment 1100 within which an elevation analysis system may operate, according to various embodiments described herein. The environment 1100 includes an elevation analysis system 1101, external geographic information system (“GIS”) data 1103, and a user device 1105. The elevation analysis system 1101 may be similar to, and may perform functions similar to, the elevation analysis system 100, described above in connection with FIG. 1. The elevation analysis system 1100 includes a web interface 1111, a GIS layer and geoprocessing tools block 1113, and blob data storage 1115.

The web interface 1111 is an interface that the elevation analysis system uses to interact with, receive data from, send data to, etc., the user device 1105 and external GIS data 1103. The external GIS data 1103 may be or include one or more systems that store, make accessible to the elevation analysis system 1101, or some combination thereof, GIS data. The GIS data may be or include any geographic data, such as one or more maps, images, or other data types, that indicate geographic data for a geographic area. In some embodiments, the GIS data includes base map data, geocoder data, other geographic data for a geographic area, or some combination thereof.

The GIS layer and geoprocessing tools 1113 include GIS data stored by the elevation analysis system and tools used by the elevation analysis system to access, identify, and analyze GIS data, such as by using the processes 200, 600, and 700 described above in connection with FIGS. 2, 6, and 7. The GIS layer and geoprocessing tools 1113 may include geographic data including elevation data, reference data, a modified Mercalli index, a location of one or more buildings, a size of one or more buildings, a shape of one or more buildings, a lahar presence, a soil type, a liquefication susceptibility of a geographic area, a tsunami risk of a geographic area, a distance to a fault line from one or more locations in a geographic area, a flood zone designation for a geographic area, other geographic data, or some combination thereof. The elevation analysis system may use the geographic data stored in the GIS layer and geoprocessing tools 1113 to obtain geographic data at one or more resolutions from geographic data stored in the blob data storage 1115, such as by identifying the reference data location of a raster image etc.

The blob data storage 1115 includes a large number of elevation and slope geographic data. In some embodiments, the elevation analysis system 1101 receives geographic data for a geographic area by identifying a name, a memory location, a file-path, other identifying information, or some combination thereof, of a raster image based on an indication of the geographic area included in the GIS layer and geoprocessing tools 1113. In some embodiments the elevation analysis system 1101 copies a portion of an image stored in the blob data storage 1115 and stores the portion of the image in a geodatabase in the GIS layer and geoprocessing tools 1113. In some embodiments, the elevation analysis system 1101 stores a reference dataset of raster images, etc., stored in the blob data storage system 1115. In such embodiments, the elevation analysis system 1101 may use the stored reference dataset to obtain geographic data associated with a geographic area without having to store a copy of the raster image, etc. In some embodiments, the elevation analysis system 1101 standardizes the geographic data associated with a portion of a raster image, vector feature, etc., by converting the geographic data, to a single projection, raster image, vector feature, etc., of a geographic area for which the elevation analysis system 1101 is performing geographic data analysis. The various embodiments described above can be combined to provide further embodiments.

Moreover, these and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. One or more instances of non-transitory computer-readable media collectively having contents configured to cause a computing device to perform a method for structure elevation analysis, the method comprising:
receiving input indicating a geographic area including a structure and a line segment within the geographic area, the line segment representing a first portion of the geographic area;
identifying a structure located within the geographic area;
generating a geo-database representing the geographic area and the line segment based on the identified structure, the line segment, and the geographic area;
receiving an indication of elevation data based on the geographic area and the identified structure;
adjusting the geo-database based on the elevation data, wherein adjusting the geo-database includes converting the line segment to a series of two or more points;
for each respective point of the two or more points:
identifying a point adjacent on the line segment to the respective point; and
determining a slope of the geographic area between the point and the respective point based on the elevation data;
determining a total slope of the first portion of the geographic area represented by the line segment based on the slope determined for each point of the two or more points; and
generating a data record indicating the total slope of the first portion of the geographic area.

2. The one or more instances of non-transitory computer-readable media of claim 1, wherein generating the data record further comprises:
rendering a representation of the structure, geographic area, line segment, and total slope based on the geo-database, the rendered representation including an indication of the elevation or a calculated slope of one or more portions of the geographic area.

3. The one or more instances of non-transitory computer-readable media of claim 1, wherein generating the data record further comprises:
generating one or more graphs indicating the total slope of the first portion of the geographic area represented by the line segment relative to the structure.

4. The one or more instances of non-transitory computer-readable media of claim 1, wherein receiving the elevation data further comprises:
transmitting an indication of the geographic area to an elevation data repository;
receiving, from the elevation data repository, elevation data representing the geographic area;
identifying a portion of the elevation data based on the geographic area and the identified structure, the portion of the elevation data representing elevation data for a section of the geographic area on which the structure is located.

5. The one or more instances of non-transitory computer-readable media of claim 1, wherein generating the geo-database further comprises:
identifying a second portion of the geographic area based on the geographic data and the identified structure, the second portion of the geographic area representing a section of the geographic area on which the structure is located; and
generating a shape of the geographic area based on the input indicating the geographic area and the second portion of the geographic area.

6. The one or more instances of non-transitory computer-readable media of claim 1, wherein adjusting the geo-database further comprises:
receiving geographic data associated with the geographic area based on a raster image;
detecting whether the portion of the geographic area represented by the line segment intersects with the location of a structure within the geographic area; and
selecting two or more points on the line segment based on the intersection of the geographic area represented by the line segment with the location of the structure within the geographic area.

7. The one or more instances of non-transitory computer-readable media of claim 1, wherein receiving input indicating the geographic area includes:
causing a user interface to be presented to a user, the user interface comprising:
a map;
a shape that indicates a geographic area;
an indication of one or more structures; and
an indication of one or more line segments within the shape;
receiving input indicating that the shape should be changed or that one or more line segments should be moved; and
identifying the geographic area and the line segment based on the shape and the indication of the one or more line segments.

8. The one or more instances of non-transitory computer-readable media of claim 1, wherein receiving an indication of elevation data includes:
identifying one or more pixel locations of the geographic area via a reference dataset; and
accessing one or more raster images that include the geographic area based on the one or more pixel locations.

9. The one or more instances of non-transitory computer-readable media of claim 1, wherein generating the data record includes:
receiving additional geographic data associated with the geographic area based on the location provided by the user or the central point of a selected structure.

10. A system comprising:
at least one processor; and
at least one memory coupled to the at least one processor, the at least one memory having computer-executable instructions stored thereon that, when executed by the at least one processor, cause the system to:
receive input indicating a geographic area including a structure and a line segment within the geographic area, the line segment representing a first portion of the geographic area;
identify a structure located within the geographic area;
generate a geo-database representing the geographic area and the line segment based on the identified structure, the line segment, and the geographic area;
receive an indication of elevation data based on the geographic area and the identified structure;
adjust the geo-database based on the elevation data, wherein adjusting the geo-database includes converting the line segment to a series of two or more points;
for each respective point of the two or more points:
identify a point adjacent on the line segment to the respective point; and
determine a slope of the geographic area between the point and the respective point based on the elevation data;
determine a total slope of the first portion of the geographic area represented by the line segment relative to the structure based on the slope determined for each point of the two or more points; and
generate a data record indicating the total slope of the first portion of the geographic area relative to the structure.

11. The system of claim 10, wherein, to generate the data record, the computer-executable instructions, when executed by the at least one processor, further cause the system to:
render a representation of the structure, geographic area, line segment, and total slope based on the geo-database, the rendered representation including an indication of the calculated slope of one or more portions of the geographic area.

12. The system of claim 10, wherein, to generate the data record, the computer-executable instructions, when executed by the at least one processor, further cause the system to:
generate one or more graphs indicating the elevation of the first portion of the geographic area represented by the line segment relative to the structure.

13. The system of claim 10, wherein, to receive the elevation data, the computer-executable instructions, when executed by the at least one processor, further cause the system to:
transmit an indication of the geographic area to an elevation data repository;
receive, from the elevation data repository, elevation data representing the geographic area;
identify a portion of the elevation data based on the geographic area, the portion of the elevation data representing elevation data for a section of the geographic area.

14. The system of claim 10, wherein, to generate the geo-database, the computer-executable instructions, when executed by the at least one processor, further cause the system to:
identify a second portion of the geographic area based on the geographic data and the identified structure, the second portion of the geographic area representing a section of the geographic area on which the structure is located; and
generate a shape of the geographic area based on the input indicating the geographic area and the second portion of the geographic area.

15. The system of claim 10, wherein, to adjust the geo-database, the computer-executable instructions, when executed by the at least one processor, further cause the system to:
receive geographic data of the geographic area based on a raster image including the geographic area;
detect whether the portion of the geographic area represented by the line segment intersects with the location of the structure within the geographic area; and
select two or more points on the line segment based on the intersection of the geographic area represented by the line segment with the location of the structure within the geographic area.

16. The system of claim 10, wherein, to receive the input indicating the geographic area, the computer-executable instructions, when executed by the at least one processor, further cause the system to:
cause a user interface to be presented to a user, the user interface comprising:
a map;
a shape that indicates a geographic area;
an indication of one or more structures; and
an indication of one or more line segments within the shape;
receive input indicating that the shape should be changed or that one or more line segments should be moved; and
identify the geographic area and the line segment based on the shape and the indication of the one or more line segments.

17. One or more storage devices collectively storing an elevation data structure, the data structure comprising:
information specifying a geographic area including a structure;
information specifying a line segment within the geographic area, the line segment representing a first portion of the geographic area;
information specifying elevation data;
information specifying two or more points on the line segment; and
information specifying a total slope of a first portion of the geographic area, such that the information specifying the geographic area and the information specifying the line segment are usable to generate a geo-database representing the geographic area and the line segment based on the structure included in the geographic area,
the geo-database is adjusted based on the information specifying the elevation data, wherein adjusting the geo-database includes converting the line segment to a series of two or more points, and
that the total slope is determined based on a plurality of slopes of the first portion of the geographic area, each of the plurality of slopes indicating a slope between a first point of the two or more points and a second point of the two or more points that is adjacent to the first point.

18. The one or more storage devices of claim 17, wherein the elevation data structure further comprises:
information specifying a data record indicating the total slope of the first portion of the geographic area relative to the structure,
such that the information specifying the data record is usable to render a representation of the structure, geographic area, line segment, and total slope based on the geo-database, the rendered representation including an indication of the calculated slope of one or more portions of the geographic area.

19. The one or more storage devices of claim 17, wherein the elevation data structure further comprises:
information specifying a data record indicating the total slope of the first portion of the geographic area relative to the structure,
such that the information specifying the data record is usable to generate one or more graphs indicating the elevation of the first portion of the geographic area represented by the line segment relative to the structure.

20. The one or more storage devices of claim 17, wherein the elevation data structure further comprises:
information specifying a portion of the elevation data that represents elevation data for a section of the geographic area on which the structure is located,
such that the information specifying the portion of the elevation data is obtained by identifying a portion of the elevation data based on the geographic area and discarding elevation data outside the geographic area.

21. The one or more storage devices of claim 20, wherein the elevation data structure further comprises:
information specifying the geo-database, comprising:
information specifying a second portion of the geographic area representing a section of the geographic area on which the structure is located; and
information specifying a polygon representation of the geographic area,
such that the information specifying the second portion of the geographic area is usable to generate the shape of the geographic area.

22. The one or more storage devices of claim 21, wherein the information specifying the geo-database further comprises:
information specifying a raster image including the geographic area,
such that the information specifying the raster image is received by identifying one or more pixels of a reference image associated with the geographic area, and
two or more points on the line segment that are selected based on the intersection of the geographic area represented by the line segment with the location of the structure within the geographic area.
